(19) United States
(12) Patent Application Publication
(10) Pub. No.: US 2026/0140077 A1
(43) Pub. Date: May 21, 2026

(54) APPARATUS AND METHOD FOR MEASURING HYDROGEN CONCENTRATION USING TEMPERATURE SENSORS

(71) Applicants: HYUNDAI MOTOR COMPANY, Seoul (KR); KIA CORPORATION, Seoul (KR)

(72) Inventor: Jinkyo Jeong, Hwaseong-si (KR)

(73) Assignees: HYUNDAI MOTOR COMPANY, Seoul (KR); KIA CORPORATION, Seoul (KR)

(21) Appl. No.: 19/094,385

(22) Filed: Mar. 28, 2025

(30) Foreign Application Priority Data
Nov. 19, 2024 (KR) 10-2024-0165372

(51) Int. Cl. G01N 25/18; G01N 25/58

(52) U.S. Cl. CPC G01N 25/18; G01N 25/58

(57) ABSTRACT

An apparatus for calculating a hydrogen concentration using a plurality of temperature sensors includes a plurality of thermal conductive temperature sensors configured to heat a plurality of heating elements to measure heating element measurement values including at least one of a temperature of an individual heating element, a resistance of the individual heating element, or a time constant of the individual heating element. The apparatus also includes an external temperature sensor configured to measure a temperature of an external gas while being insulated from the plurality of heating elements. The apparatus further includes a processor configured to determine a hydrogen concentration based on the plurality of heating element measurement values and the temperature of the external gas.

### CROSS-REFERENCE TO RELATED APPLICATION

This present application claims the benefit of and priority to Korean Patent Application No. 10-2024-0165372, filed on Nov. 19, 2024, the entire contents of which are hereby incorporated herein by reference.

### TECHNICAL FIELD

The present disclosure relates to an apparatus and a method for measuring a hydrogen concentration using temperature sensors.

### BACKGROUND

Generally, fossil fuels have been the main source of global energy supply, but their prospects are uncertain due to recent depletion of fossil fuel reserves and environmental problems. Hydrogen energy is attracting attention as a storage medium for various alternative energies to address the energy supply and demand issues and as a clean energy source for electric vehicles and industrial energy. However, hydrogen has a high flash point and has the property of exploding when its concentration exceeds a certain level, so that a hydrogen sensor that can detect hydrogen leakage during handling becomes important.

Accordingly, sensors using an electrical method that utilizes the change in the electrical conductivity of metals, such as platinum and palladium, due to the adsorption of hydrogen on them, sensors using an electrochemical method, and sensors using an optical method that detect hydrogen leakage using light have been developed.

In addition, thermal conductive hydrogen sensors have several advantages, in terms of reproducibility, stability, cost, power consumption, simple structure, response time, lifespan, dynamic range (DR), and small installation area.

However, in the case of the thermal conductive hydrogen sensors, there is noise in the thermal conductivity due to the atmospheric temperature and humidity in the atmosphere, so that a thermal conductivity with respect to the atmospheric temperature and the relative humidity needs to be compensated.

However, when the thermal conductive hydrogen sensor of the related art is used for a long time, there is a problem in that a desiccant in the humidity sensor deteriorates due to moisture.

Further, humidity sensors for vehicles have to be located in a closed space where a large amount of volatile organic compounds (VOC) are collected, so that there is a problem in that the humidity cannot be accurately measured due to the descant poisoned by the VOC.

The statements in this Background section merely provide background information related to the present disclosure and may not constitute prior art.

### SUMMARY

The present disclosure has been created to solve the problems as described above. An object achieved by the present disclosure is to provide an apparatus and a method for calculating a hydrogen concentration using a plurality of temperature sensors, to calculate a hydrogen concentration in the atmosphere by utilizing a plurality of temperature sensors, without using a humidity sensor.

Another object of the present disclosure is to provide an apparatus and a method for calculating a hydrogen concentration using a plurality of temperature sensors, to calculate a hydrogen concentration in the atmosphere by varying heating rates of individual heating elements.

Still another object of the present disclosure is to provide an apparatus and a method for calculating a hydrogen concentration using a plurality of temperature sensors, to accurately calculate a hydrogen concentration by diagnosing a failure of a sensor and/or an error of a calculated hydrogen concentration.

Objects of the present disclosure are not limited to the above-mentioned object. Other objects and advantages of the present disclosure, that are not mentioned, should be more clearly understood by those having ordinary skill in the art from the following description. It should also to be understood that the objects and advantages of the present disclosure may be realized by means and combinations thereof set forth in claims.

According to an aspect of the present disclosure, an apparatus for determining a hydrogen concentration using a plurality of temperature sensors is provided. The apparatus comprises a plurality of thermal conductive temperature sensors configured to heat a plurality of heating elements to measure a plurality of heating element measurement values including at least one of a temperature of an individual heating element, a resistance of the individual heating element, or a time constant of the individual heating element. The apparatus also includes an external temperature sensor configured to measure a temperature of an external gas insulated from the heating elements. The apparatus additionally includes a calculating unit configured to calculate a hydrogen concentration based on the plurality of heating element measurement values and the temperature of the external gas.

According to another aspect of the present disclosure, a method for determining a hydrogen concentration using a plurality of temperature sensors is provided. The method includes measuring, by heating a plurality of heating elements, a plurality of heating element measurement values including at least one of a temperature of an individual heating element, a resistance of the individual heating element, or a time constant of the individual element. The method also includes measuring a temperature of an external gas insulated from the heating elements. The method additionally includes determining a hydrogen concentration based on the plurality of heating element measurement values and the temperature of the external gas.

According to yet another aspect of the present disclosure, an apparatus for determining a hydrogen concentration using a plurality of temperature sensors is provided. The apparatus includes a plurality of thermal conductive temperature sensors configured to heat a plurality of heating elements, and measure a plurality of heating element measurement values, including measuring, for each of the plurality of heating elements, at least one of a temperature of the heating element, a resistance of the heating element, or a time constant of the heating element. The apparatus also includes an external temperature sensor configured to measure a temperature of an external gas insulated from the plurality of heating elements. The apparatus further includes at least one processor configured to determine a hydrogen concentration based on the plurality of heating element measurement values and the temperature of the external gas.

According to embodiments of the present disclosure, a plurality of temperature sensors is utilized without using a humidity sensor to suppress inaccurate humidity compensation according to deterioration of a desiccant in the humidity sensor due to the moisture in the atmosphere and poisoned desiccant due to VOC, thereby accurately calculating the hydrogen concentration.

Further, according to embodiments of the present disclosure, heating rates of heating elements in a plurality of cavities are set to be different from each other so that influence of measurement values of heating elements of a sensor due to the humidity and the thermal conductivity of the hydrogen is distinguished, thereby accurately calculating the hydrogen concentration in the atmosphere.

Further, according to embodiment of the present disclosure, the failure and the error of the calculated hydrogen concentration are diagnosed to automate the diagnosis of a hydrogen concentration calculating apparatus, thereby calculating a reliable hydrogen concentration.

### BRIEF DESCRIPTION OF THE DRAWINGS

The above and other aspects, features, and advantages of the present disclosure should become more apparent from the detailed description below in conjunction with the accompanying drawings, in which:

FIG. 1 is a diagram illustrating an apparatus for calculating a hydrogen concentration using a plurality of temperature sensors, according to an embodiment of the present disclosure;

FIG. 2 is a detailed diagram of an apparatus for calculating a hydrogen concentration using a plurality of temperature sensors, according to an embodiment of the present disclosure;

FIG. 3 is a flowchart illustrating a method for calculating a hydrogen concentration using a plurality of temperature sensors, according to an embodiment of the present disclosure;

FIG. 4 is a flowchart of a method for compensating for a temperature and a humidity using a plurality of temperature sensors, according to an embodiment of the present disclosure;

FIGS. 5A and B are a plan view and a side cross-sectional view, respectively, illustrating a micro electro mechanical system (MEMS) sensor in which heating elements with different heat generation rates are disposed in a plurality of cavities and the same voltage is applied to individual heating elements, according to an embodiment of the present disclosure;

FIG. 6 is a graph illustrating a thermal conductivity by gas according to a temperature, according to an embodiment of the present disclosure;

FIGS. 7A and B are graphs illustrating a thermal conductivity of vapour (H₂O) mixed gas according to an absolute humidity and a relative humidity, according to embodiments of the present disclosure; and

FIGS. 8A-C are graphs illustrating a concentration of hydrogen by measuring vapour mixed gas at every absolute humidity with an IFX thermal conductive sensor, a STC31 thermal conductive sensor, and a PGS1000 thermal conductive sensor, according to embodiments of the present disclosure.

### DETAILED DESCRIPTION

Hereinafter, embodiments of the present disclosure are described in detail with reference to the accompanying drawings. In the accompanying drawings and the description below, the same or similar elements are denoted by the same reference numerals even when the elements are depicted in different drawings, and a redundant description thereof is omitted. In the following description of the embodiments, suffixes, such as “module”, and “part”, are provided or used interchangeably merely in consideration of ease in statement of the specification, and do not have meanings or functions distinguished from one another. In the following description, a detailed description of known functions and configurations incorporated herein has been omitted where it was determined that the detailed description would obscure the gyst of the present disclosure. Further, the accompanying drawings illustrative of the embodiments of the present disclosure. The present disclosure should not be construed as being limited to the embodiments set forth herein. It should be understood that the embodiments of the present disclosure are provided only to completely disclose the disclosure. Modifications, equivalents or alternatives of the described embodiments are included within the scope and technical range of the present disclosure.

In the following description of the embodiments, terms, such as “first” and “second”, are used only to describe various elements, and these elements should not be construed as being limited by these terms. These terms are used only to distinguish one element from other elements.

When an element or layer is referred to as being “connected to” or “coupled to” another element or layer, the element may be directly connected or coupled to the other element or layer, or intervening elements or layers may be present. In contrast, when an element or layer is referred to as being “directly connected to” or “directly coupled to” another element or layer, there may be no intervening elements or layers present.

When a component, device, element, or the like of the present disclosure is described as having a purpose or performing an operation, function, or the like, the component, device, or element should be considered herein as being “configured to” meet that purpose or perform that operation or function. Each component, controller, device, unit, module, element, apparatus, and the like may separately embody or be included with at least one processor and at least one memory, such as a non-transitory computer readable media, as part of the apparatus.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

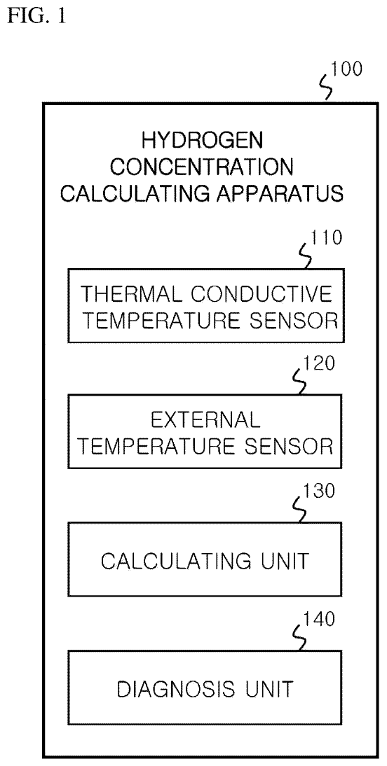

Hereinafter, an apparatus and a method for calculating a hydrogen concentration using a plurality of temperature sensors according to embodiments of the present disclosure are described in detail with reference to FIGS. 1-8C.

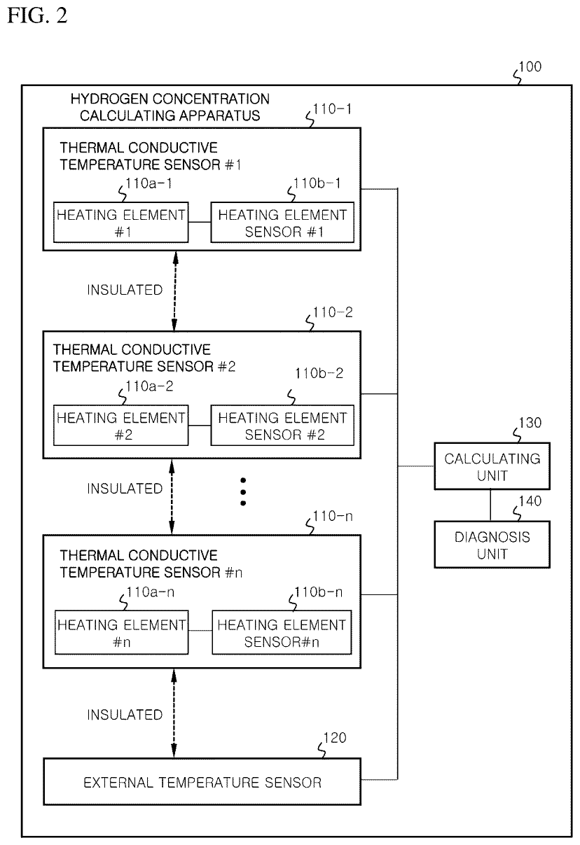

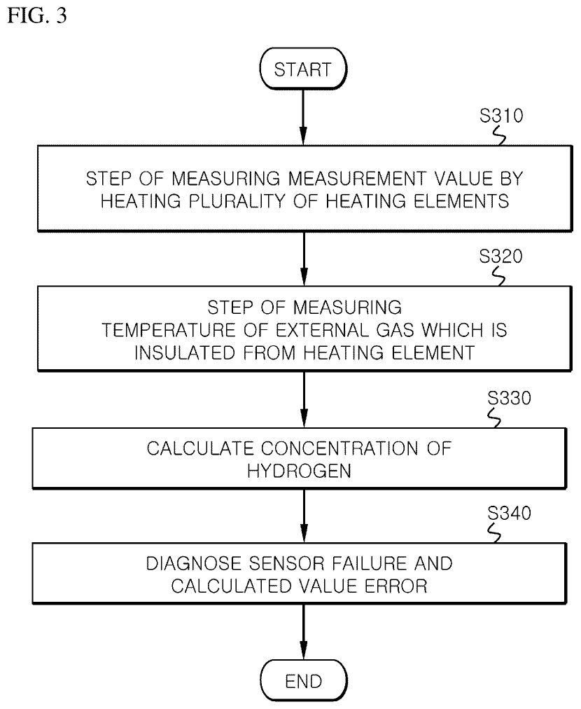

FIG. 1 is a diagram illustrating an apparatus for calculating a hydrogen concentration using a plurality of temperature sensors, according to an embodiment of the present disclosure. FIG. 2 is a detailed diagram of an apparatus for calculating a hydrogen concentration using a plurality of temperature sensors, according to an embodiment of the present disclosure. FIG. 3 is a flowchart illustrating a method for calculating a hydrogen concentration using a plurality of temperature sensors, according to an embodiment of the present disclosure.

Referring to FIGS. 1-3, a hydrogen concentration calculating apparatus 100 using a plurality of temperature sensors according to an embodiment of the present disclosure comprises a thermal conductive temperature sensor 110, an external temperature sensor 120, a calculating unit 130, and a diagnosis unit 140.

In an operation S310 of FIG. 3, the thermal conductive temperature sensor 110 may heat each of a plurality of heating elements to obtain (e.g., measure), for each of the plurality of heating elements, a heating element measurement value including at least one of a temperature of an individual heating element, a resistance of the individual heating element, or a time constant of the individual heating element.

For example, the heating element may be a micro-electro mechanical system (MEMS) heating element that enables Joule heating or a metal wire coil.

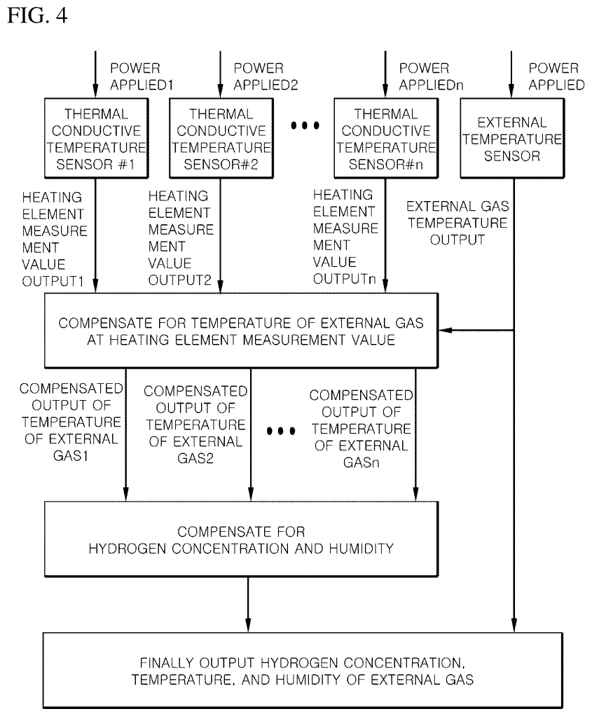

FIG. 4 is a flowchart of a method for compensating for a temperature and a humidity using a plurality of temperature sensors according to an embodiment of the present disclosure.

Referring to FIG. 4, a power is applied to individual heating elements 110a-1, 110a-2, . . . , 110a-n of a plurality of thermal conductive temperature sensors.

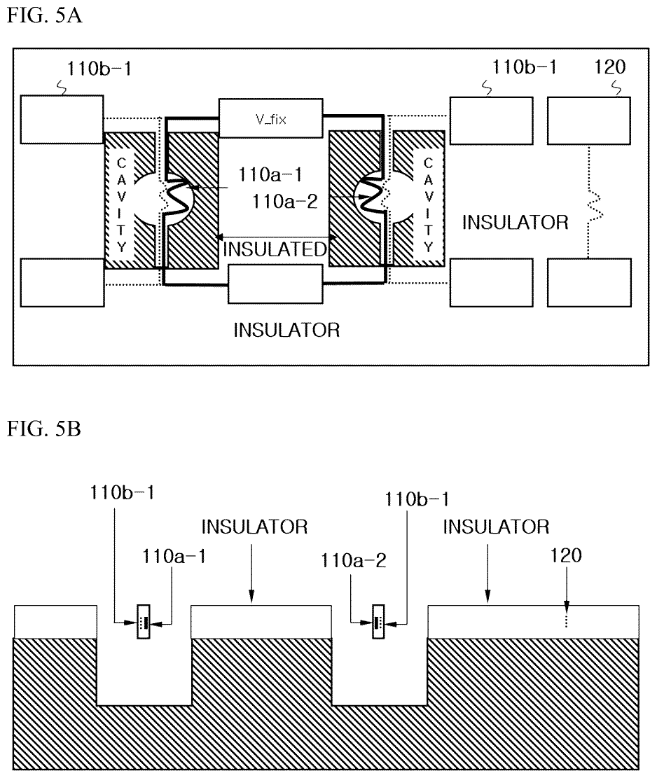

FIG. 5A is a plan view illustrating a micro electro mechanical system (MEMS) sensor in which a heating element with a different heat generation rate is disposed in each cavity, according to an embodiment of the present disclosure, and the same voltage is applied to each heating element. FIG. 5B is a side cross-sectional view of the MEMS sensor of FIG. 5A.

Referring to FIG. 5A, according to an embodiment of the present disclosure, the same fixed voltage is applied to heating elements having different resistance to heat the heating elements with different heat generation rates.

Referring to FIG. 5B, the thermal conductive temperature sensor 110 includes a heating element 110a and a heating element sensor 110b.

According to an embodiment of the present disclosure, a hydrogen concentration value is calculated based on thermal conduction phenomenon of gas. In an embodiment, a cavity is configured to allow external air to flow in to reduce convection phenomenon of the gas.

In an embodiment, as the heating element, an MEMS heating element that is quickly heated may be used. Accordingly, the gas convection may be minimized to measure the influence by the thermal conductivity of the gas. Accordingly, as described in more detail below, a composition of gas may be estimated by the calculating unit 130 by approximating with heat conduction equation (for example, Fourier's law of heat conduction).

For example, the heating element is heated by the Joule heating over time, according to a voltage applied to the heating element. The heating process varies according to thermal conductivity of the gas with which the heating element emits heat to surrounding gas and the heating process is measured by a nearby heating element sensor.

In some embodiments, depending on how the thermal conductive temperature sensor output is measured, a heating element sensor may not be included in the configuration. For example, when the metal wire coil is used, the resistance or the time constant of the heating element may be used, instead of the measurement value in the heating element sensor.

On the other hand, as illustrated in FIGS. 5A and 5B, in an embodiment in which the MEMS heating element is used, the heating element sensor that measures a temperature of the heating element may be included in the configuration.

In an operation S320 of FIG. 3, the external temperature sensor 120 measures the temperature of external gas that is insulated from the plurality of heating elements.

However, the thermal conductivity of the gas itself strongly depends on the temperature, so that the external temperature sensor 120 may be disposed to be insulated from the heating element to compensate for the temperature.

In an operation S330 of FIG. 3, the calculating unit 130 determines (e.g., calculates) a hydrogen concentration based on of the plurality of heating element measurement values and the temperature of the external gas.

For example, information about the thermal conductivity of the external gas is estimated based on an electric energy consumed in the heating element, a resistance change of the individual heating element, a time constant of a heating element sensor resistance, and a temperature measured by the heating element sensor and hydrogen concentration and humidity comprised in the external gas are estimated based on information about the plurality of estimated thermal conductivities.

In an embodiment, the calculating unit 130 determines (e.g., calculates) a plurality of thermal conductivities of the external gas based on the temperature of the external gas and the plurality of heating element measurement values.

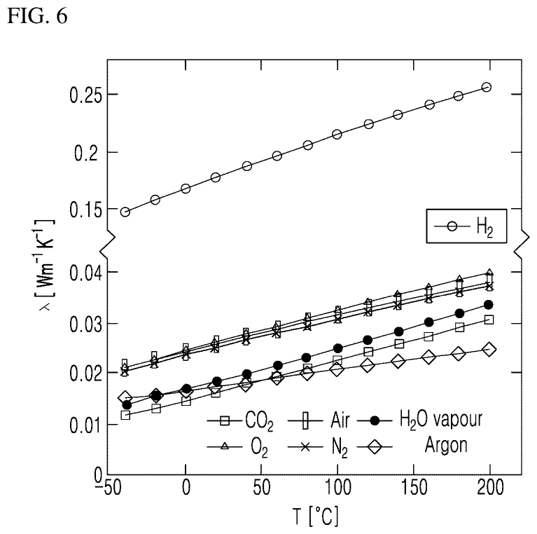

FIG. 6 is a graph illustrating a thermal conductivity for every gas according to a temperature, according to an embodiment of the present disclosure.

Referring to FIG. 6, the difference in the air thermal conductivity from 0° C. to 60° C. is approximately 4.4 mW/mK.

The difference in thermal conductivity of 100% of air, 99.9% of air, and 0.1% H₂ (that is, 1000 ppm of hydrogen) is approximately 0.04 mW/mK. Accordingly, before calculating the influence by the concentration for every gas, influence by the temperature of the external gas needs to be compensated.

For example, a method for algorithmically compensating for a temperature using a post-processing method of hardware or software with a separate temperature sensor may be used.

The calculating unit 130 determines (e.g., calculates) a hydrogen concentration including a plurality of humidity noises in accordance with a plurality of thermal conductivities of the external gas.

For example, when all the thermal conductivities by the vapor and the hydrogen are assumed as thermal conductivity by the hydrogen, as the hydrogen concentration including the humidity noise, a corresponding hydrogen concentration is calculated.

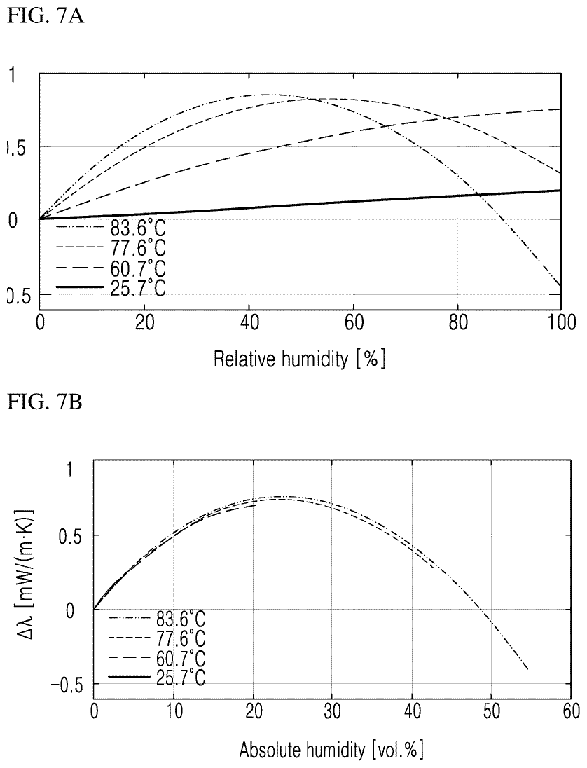

FIG. 7A is a graph illustrating a conductivity of vapour (H₂O) mixed gas according to a relative humidity. FIG. 7B is a graph illustrating a thermal conductivity of vapour mixed gas according to an absolute humidity.

A thermal conductivity of wet air is different from a thermal conductivity of dry air so that the influence by the humidity needs to be distinguished.

Accordingly, the calculating unit 130 calculates the hydrogen concentration at every absolute humidity based on the temperature of the external gas.

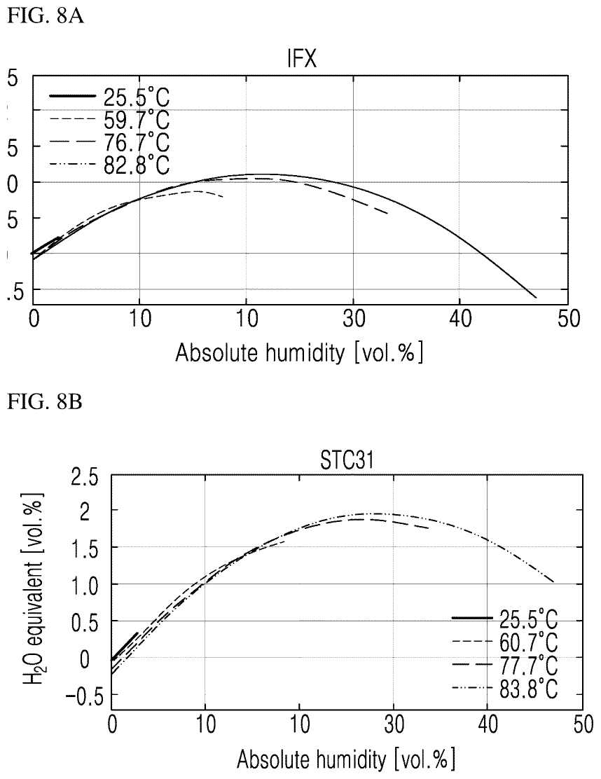

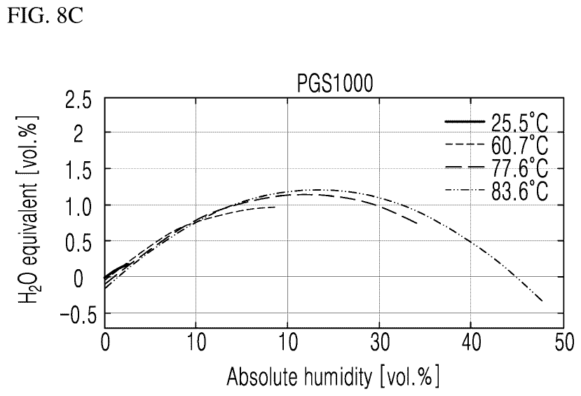

For example, FIG. 8A is a graph illustrating a concentration of hydrogen obtained by measuring a vapor mixed gas at every absolute humidity using the IFX sensor which is a thermal conductive sensor, FIG. 8B is a graph illustrating a concentration of hydrogen obtained by measuring a vapor mixed gas at every absolute humidity using the STC31 sensor which is a thermal conductive sensor, and FIG. 8C is a graph illustrating a concentration of hydrogen obtained by measuring a vapor mixed gas at every absolute humidity using the PGS1000 sensor which is a thermal conductive sensor.

Referring to FIGS. 8A and 8C, when a gas with an absolute humidity of approximately 50 vol % is measured using the IFX and PGS 1000 thermal conductive sensors, a hydrogen concentration corresponding to the measured thermal conductivity is-0.5 vol %.

In contrast, referring to FIG. 8B, when a gas with an absolute humidity of approximately 50 vol % is measured with the STC31 thermal conductive sensors, a hydrogen concentration corresponding to the measured thermal conductivity is-1.0 vol %.

Referring to FIG. 7A, the influence of humidity is much stronger at the high temperature and as the temperature and the humidity increase, the humidity compensation is especially important.

Referring to FIG. 7B, when the influence by the temperature is removed, the thermal conductivity of the gas greatly depends on the absolute humidity.

Referring to FIGS. 7A and 7B, it is confirmed that the thermal conductivity of the gas linearly increases according to the temperature and the humidity in a specific section.

Accordingly, based on the hydrogen concentration including a plurality of humidity noises, the hydrogen concentration at every absolute humidity, and the following Equation 1, when the heating element measurement value linearly increases according to the concentration of external gas, the calculating unit 130 may calculate separately the hydrogen concentration and the humidity based on Equation 1.

$$Hydrogen Concentration 1 = Hydrogen c oncentration 1 including a humidity noise - f ( absolute humidity 1 ) \qquad [ Equation l ]$$

$$Hydrogen Concentration 2 = Hydrogen c oncentration 2 including a humidity noise - f ( absolute humidity 2 )$$

In Equation 1, Hydrogen concentration 1 including a humidity noise is a hydrogen concentration including a humidity noise calculated based on a first heating element measurement value of a first thermal conductive temperature sensor, Hydrogen concentration 1 is a hydrogen concentration to which a measurement value increase by temperature rise of the first heating element is reflected, Absolute humidity 1 is an absolute humidity to which a measurement value increase by temperature rise of the first heating element is reflected, Hydrogen concentration 2 including a humidity noise is a hydrogen concentration including a humidity noise calculated based on a second heating element measurement value of a second thermal conductive temperature sensor, Hydrogen concentration 2 is a hydrogen concentration to which a measurement value increase by temperature rise of the second heating element is reflected, Absolute humidity 2 is an absolute humidity to which a measurement value increase by temperature rise of the second heating element is reflected, f has an absolute humidity as an input and a hydrogen concentration as an output, and k is an integer between 1 and n.

Referring to FIGS. 8A to 8C, the linearity is obtained regardless of the temperature of the thermal conductivity measurement value in a low absolute humidity range and a sensor type. On the other hand, the thermal conductivity measurement value in the high temperature and high humidity condition greatly depends on the temperature and the sensor type.

Accordingly, when the heating element measurement value does not linearly increase according to the gas concentration and the influence of quadratic or higher equation exists, the calculating unit calculates a hydrogen concentration based on the heating element measurement values of three or more thermal conductivity temperature sensors.

For example, the calculating unit 130 separately calculates the hydrogen concentration and the humidity based on the hydrogen concentration including the plurality of humidity noises, the hydrogen concentration at every absolute humidity, and the following Equation 2.

$$Hydrogen Concentration k = Hydrogen c oncentration k including a humidity noise - f ( absolute humidity k ) \qquad [ Equation 2 ]$$

In Equation 2, Hydrogen concentration k including a humidity noise is a hydrogen concentration including a humidity noise calculated based on a k-th heating element measurement value of a k-th thermal conductive temperature sensor, Hydrogen concentration k is a hydrogen concentration to which a measurement value increase by temperature rise of a k-th heating element is reflected, Absolute humidity k is an absolute humidity to which a measurement value increase by temperature rise of the k-th heating element is reflected, f has an absolute humidity as an input and a hydrogen concentration as an output, and k is an integer between 1 and n.

Referring to Equation 2, the thermal conductivity of the gas which is changed by the k-th heating element is measured by the k-th thermal conductive temperature sensor to be output as a hydrogen concentration k including the humidity noise.

The hydrogen concentration k including a humidity noise is denoted in Equation 2 with f(absolute humidity k) and a hydrogen concentration k as unknown quantities.

In Equation 2, f(absolute humidity k) and the hydrogen concentration k are values to which the measurement value increase by the temperature rise of the k-th heating element is reflected. The measurement value refers to a hydrogen concentration output value of the k-th thermal conductive temperature sensor.

The measurement value increase by the temperature rise may be calculated based on a thermal conductivity of the humidity at every temperature and a thermal conductivity of hydrogen at every temperature.

The increased temperature may be calculated based on the temperature of the external gas and the heating element measurement value.

Accordingly, the calculating unit separately calculates the hydrogen concentration and the humidity by combining the plurality of equations for f(absolute humidity k) and the hydrogen concentration k.

According to an embodiment, the method for separately calculating the concentrations for every gas using a surface thermal conductivity based on the heating element measurement value, rather than the hydrogen concentration output value of the thermal conductive temperature sensor, is as follows.

For example, when a simple Joule heating coil is used as a heating element, a surface thermal conductivity of the heating element may be calculated using a heating element measurement value of the thermal conductive temperature sensor, such as a temperature measured by the external temperature sensor and a resistance change time according to the thermal conductivity.

$${I}^{2} {R}_{T 0} ( 1 + {α}_{T} ( {T}_{H} - {T}_{∞} ) ) \approx {k}_{f} {A}_{s} ( \frac{{T}_{H} - {T}_{∞}}{L} ) \qquad [ Equation 3 ]$$

In Equation 3, R_{T0} is a resistance of a heating element at a reference temperature (generally, 25° C.), I²R_{T0} is a power consumption of the heating element, α_{T} is a gas thermal diffusivity at a temperature T, T_{H} is a maximum temperature of the heating element, To is a normal state temperature of the heating element, k_{f} is a surface thermal conductivity of the heating element, Aₛ is an area of the heating element, and L is a thickness of the heating element.

In Equation 3, a left-hand side defines a heat generation rate and a right-hand side is Fourier's law of heat conduction including a thermal conductivity of gas.

Equation 3 may be summarized as Equation 4 that defines a temperature change.

$${T}_{H} - {T}_{∞} \approx \frac{{1}^{2} {R}_{T 0}}{- {α}_{T} {1}^{2} {R}_{T 0} + \frac{{k}_{f} {A}_{s}}{L}} \qquad [ Equation 4 ]$$

In Equation 4, R_{T0} is a resistance of a heating element at a reference temperature (generally, 25° C.), I²R_{T0} is a power consumption of the heating element, α_{T} is a gas thermal diffusivity at a temperature T, T_{H} is a maximum temperature of the heating element, To is a normal state temperature of the heating element, k_{f} is a surface thermal conductivity of the heating element, Aₛ is an area of the heating element and L is a thickness of the heating element.

Referring to Equation 4, it is confirmed that the temperature change of the heating element is inversely proportional to the thermal conductivity of ambient gas.

In order to define a transient state in which temperature rises from T_{∞} to T_{H}, a transient term based on heat equation may be added.

$$\frac{dT}{dt} = α {∇}^{2} T = α [ \frac{{\partial }^{2} T}{\partial {x}^{2}} + \frac{{\partial }^{2} T}{\partial {y}^{2}} + \frac{{\partial }^{2} T}{\partial {z}^{2}} ] \qquad [ Equation 5 ]$$

In Equation 5, dT/dt is a transient term, ∇² is a Laplace operator, and α is a thermal diffusivity)

$$α = \frac{k}{{C}_{p} ρ} \qquad [ Equation 6 ]$$

In Equation 6, α is a thermal diffusivity, k is a thermal conductivity, Cₚ is a specific heat at a constant pressure, and ρ is a density of gas)

If the transient term defined by Equations 5 and 6 is added to Equation 3, Equation 3 is defined in a temporal domain as follows.

$${I}^{2} {R}_{T 0} ( 1 + {α}_{T} ( {T}_{H} - {T}_{∞} ) ) = {ρ VC}_{p} \frac{d T}{d t} + {k}_{f} {A}_{s} ( \frac{{T}_{H} - {T}_{∞}}{L} ) \qquad [ Equation 7 ]$$

In Equation 7, ρVCₚ is a thermal mass including a thermal mass of a heating element and a thermal mass of gas and dT/dt is a transient term.) Here, the thermal mass of the heating element is much larger than the thermal mass of the ambient gas so that only the thermal mass of the heating element is considered.

Referring to Equation 7, the left-hand side is a heat generation rate by a power applied to the heating element and the right-hand side is a transient state equation for thermal change of the heating element and an equation of thermal conduction.

In Equation 7, kf is considered as a thermal conductivity of the ambient gas which affects the heat radiation of the heating element.

A temperature solution as a function of time is calculated using a solution of dT/dt+T/τ=0 which is T=ae^{-t/τ}.

$${T}_{H} - {T}_{∞} = \frac{{1}^{2} {R}_{T 0} L}{- {α}_{T} {1}^{2} {R}_{T 0} L + {k}_{f} {A}_{s}} ( 1 - {e}^{\frac{- t}{τ}} ) \qquad [ Equation 8 ]$$

In Equation 8, R_{T0} is a resistance of a heating element at a reference temperature (generally, 25° C.), I²R_{T0} is a power consumption of the heating element, α_{T} is a gas thermal diffusivity at a temperature T, T_{H} is a maximum temperature of the heating element, T_{∞} is a normal state temperature of the heating element, T_{H}-T_{∞} is a temperature deviation of the external temperature sensor and the plurality of thermal conductive temperature sensors, k_{f} is a surface thermal conductivity of the heating element, Aₛ is an area of the heating element, L is a thickness of the heating element, t is a heating time constant which is a transient response time constant of a heating element resistance after heating, and t is a time variable.

Accordingly, in an embodiment, the heating time constant is calculated as follows.

$$τ = \frac{{C}_{p} L ρ V}{- {α}_{T} {1}^{2} {R}_{T 0} L + {k}_{f} {A}_{s}} \qquad [ Equation 9 ]$$

In equation 9, ρVCₚ is a thermal mass configured by a thermal mass of a heating element and a thermal mass of gas, k_{f} is a surface thermal conductivity of the heating element, Aₛ is an area of the heating element, α_{T} is a thermal diffusivity of gas at a temperature T, I²RTO is power consumption of the heating element, and Lis a thickness of the heating element.

Referring to Equation 9, the calculating unit calculates the thermal conductivity of the ambient gas using the heating time constant in the transient state of the heating element or the temperature sensor resistance.

Accordingly, the calculating unit separately calculates the hydrogen concentration and the humidity by combining a plurality of equations with humidity and a hydrogen concentration as unknown quantities.

In an operation S340 of FIG. 3, the diagnosis unit 140 diagnoses a failure of the external temperature sensor, a failure of the thermal conductive temperature sensor, an error in the calculation of a calculated hydrogen concentration, and/or an error of calculated humidity.

For example, when the temperature of the external gas is out of a predetermined normal temperature range, the diagnosis unit 140 diagnoses the external temperature sensor as faulty. As another example, when the plurality of heating element measurement values is out of a predetermined normal heating element range, the diagnosis unit 140 diagnoses the corresponding thermal conductive temperature sensor as faulty. As yet another example, when at least one of the hydrogen concentration or the absolute humidity comprised in the external gas is out of a normal concentration range, the diagnosis unit 140 diagnoses an error in the calculation of the calculated hydrogen concentration, and/or the calculated humidity.

For example, a predetermined normal temperature range with respect to the temperature of the external gas measured by the external temperature sensor may be −40 to 100 degrees celsius (° C.). Further, a predetermined normal concentration range with respect to the calculated hydrogen concentration and humidity may be a physically possible concentration range of 0 to 100%.

In the present disclosure (particularly, in the claims), use of the term “above” and similar referential terms may refer to both the singular and the plural. In addition, when a range is stated in the present disclosure, the statement comprises the case to which individual values within the range are applied (unless there is a statement to the contrary), and is the same as a statement of the individual values constituting the range in the detailed description of the disclosure.

Unless there is a statement of an explicit order or a statement to the contrary regarding steps constituting the method according to the present disclosure, the steps may be performed in any appropriate order. The present disclosure is not limited by the described order of the steps. Use of any examples or illustrative terms (for example, etc.) in the present disclosure is merely to describe the present disclosure in detail, and unless limited by the claims, the scope of the present disclosure is not limited by the examples or illustrative terms. Further, those having ordinary skill in the art should appreciate that various modifications, combinations, and changes may be made according to design conditions and factors within the scope of the appended claims or their equivalents.

Therefore, the spirit of the present disclosure is not limited to the above-described embodiments, and the scope of the appended claims as well as all scopes equivalent to or equivalently changed from the claims are within the scope of the spirit of the present disclosure.

What is claimed is:

1. An apparatus for determining a hydrogen concentration using a plurality of temperature sensors, the apparatus comprising:
a plurality of thermal conductive temperature sensors configured to heat a plurality of heating elements to measure a plurality of heating element measurement values including at least one of a temperature of an individual heating element, a resistance of the individual heating element, or a time constant of the individual heating element;
an external temperature sensor configured to measure a temperature of an external gas insulated from the plurality of heating elements; and
a calculating unit configured to determine a hydrogen concentration based on the plurality of heating element measurement values and the temperature of the external gas.

2. The apparatus according to claim 1, wherein the calculating unit is configured to:
determine a plurality of thermal conductivities of the external gas based on a temperature of the external gas and the plurality of heating element measurement values;
determine a hydrogen concentration including a plurality of humidity noises corresponding to the plurality of thermal conductivities of the external gas; and
determine a hydrogen concentration for every absolute humidity based on the temperature of the external gas.

3. The apparatus according to claim 2, wherein:
the plurality of thermal conductive temperature sensors includes first to n-th thermal conductive temperature sensors;
the plurality of heating elements includes first to n-th heating elements;
the plurality of heating element measurement values includes first to n-th heating element measurement values; and
the calculating unit is configured to determine the hydrogen concentration and the absolute humidity based on the hydrogen concentration including the plurality of humidity noises and the hydrogen concentration for every absolute humidity, according to Hydrogen Concentration k=Hydrogen concentration k including humidity noise−f(absolute humidity k),
wherein:
Hydrogen concentration k including a humidity noise is a hydrogen concentration including a humidity noise calculated based on a k-th heating element measurement value of a k-th thermal conductive temperature sensor,
Hydrogen concentration k is a hydrogen concentration to which a measurement value increase by temperature rise of a k-th heating element is reflected,
Absolute humidity k is an absolute humidity to which a measurement value increase by temperature rise of the k-th heating element is reflected,
f has an absolute humidity as an input and a hydrogen concentration as an output, and
k is an integer between 1 and n.

4. The apparatus according to claim 3, further comprising a diagnosis unit configured to:
diagnose the external temperature sensor as faulty based on determining that the temperature of the external gas is out of a predetermined normal temperature range.

5. The apparatus according to claim 4, wherein the diagnosis unit is further configured to diagnose a thermal conductive temperature sensor as faulty based on determining that at least one of the plurality of heating element measurement values is out of a predetermined normal heating element range.

6. The apparatus according to claim 4, wherein the diagnosis unit is configured to, based on determining that at least one of the hydrogen concentration or the absolute humidity in the external gas is out of a predetermined normal concentration range, diagnose an error in one or both of the hydrogen concentration or the absolute humidity determined by the calculating unit.

7. The apparatus of claim 1, wherein the plurality of heating elements comprises a plurality of micro-electro mechanical system (MEMS) heating elements.

8. A method for determining a hydrogen concentration using a plurality of temperature sensors, the method comprising:
measuring, by heating a plurality of heating elements, a plurality of heating element measurement values including at least one of a temperature of an individual heating element, a resistance of the individual heating element, or a time constant of the individual heating element;
measuring a temperature of an external gas insulated from the plurality of heating elements; and
determining a hydrogen concentration based on the plurality of heating element measurement values and the temperature of the external gas.

9. The method according to claim 8, wherein determining the hydrogen concentration includes:
determining a plurality of thermal conductivities of the external gas based on the temperature of the external gas and the plurality of heating element measurement values;
determining a hydrogen concentration including a plurality of humidity noises corresponding to the plurality of thermal conductivities of the external gas; and
determining a hydrogen concentration for every absolute humidity based on the temperature of the external gas.

10. The method according to claim 9, wherein:
the plurality of heating elements includes first to n-th heating elements;
the plurality of heating element measurement values includes first to n-th heating element measurement values; and
determining the hydrogen concentration includes determining the hydrogen concentration and the absolute humidity based on the hydrogen concentration including the plurality of humidity noises and the hydrogen concentration for every absolute humidity, according to:
Hydrogen Concentration k=Hydrogen concentration k including humidity noise−f(absolute humidity k),
wherein:
Hydrogen concentration k including a humidity noise is a hydrogen concentration including a humidity noise calculated based on a k-th heating element measurement value,
Hydrogen concentration k is a hydrogen concentration to which a measurement value increase by temperature rise of a k-th heating element is reflected,
Absolute humidity k is an absolute humidity to which a measurement value increase by temperature rise of the k-th heating element is reflected,
f has an absolute humidity as an input and a hydrogen concentration as an output, and
k is an integer between 1 and n.

11. The method according to claim 10, further comprising:
diagnosing an external temperature sensor as faulty based on determining that the temperature of the external gas is out of a predetermined normal temperature range; and
diagnosing a thermal conductive temperature sensor as faulty based on determining that at least one of the plurality of heating element measurement values is out of a predetermined normal heating element range.

12. The method according to claim 11, further comprising diagnosing an error in one or both of the determined hydrogen concentration or the determined absolute humidity based on determining that at least one of the hydrogen concentration or the absolute humidity in the external gas is out of a predetermined normal concentration range.

13. The method of claim 8, wherein measuring the plurality of heating element measurement values includes measuring the plurality of heating element measurement values by heating a plurality of micro-electro mechanical system (MEMS) heating elements.

14. An apparatus for determining a hydrogen concentration using a plurality of temperature sensors, the apparatus comprising:
a plurality of thermal conductive temperature sensors configured to
heat a plurality of heating elements, and
measure a plurality of heating element measurement values, including measuring, for each of the plurality of heating elements, at least one of a temperature of the heating element, a resistance of the heating element, or a time constant of the heating element;
an external temperature sensor configured to measure a temperature of an external gas insulated from the plurality of heating elements; and
at least one processor configured to determine a hydrogen concentration based on the plurality of heating element measurement values and the temperature of the external gas.

15. The apparatus according to claim 14, wherein the at least one processor is configured to:
determine a plurality of thermal conductivities of the external gas based on the temperature of the external gas and the plurality of heating element measurement values;
determine a hydrogen concentration including a plurality of humidity noises corresponding to the plurality of thermal conductivities of the external gas; and
determine a hydrogen concentration for every absolute humidity based on the temperature of the external gas.

16. The apparatus according to claim 15, wherein:
the plurality of thermal conductive temperature sensors includes first to n-th thermal conductive temperature sensors;
the plurality of heating elements includes first to n-th heating elements;
the plurality of heating element measurement values includes first to n-th heating element measurement values; and
the at least one processor is configured to determine the hydrogen concentration and the absolute humidity based on the hydrogen concentration including the plurality of humidity noises and the hydrogen concentration for every absolute humidity, according to Hydrogen Concentration k=Hydrogen concentration k including humidity noise-f(absolute humidity k),
wherein:
Hydrogen concentration k including a humidity noise is a hydrogen concentration including a humidity noise calculated based on a k-th heating element measurement value of a k-th thermal conductive temperature sensor,
Hydrogen concentration k is a hydrogen concentration to which a measurement value increase by temperature rise of a k-th heating element is reflected,
Absolute humidity k is an absolute humidity to which a measurement value increase by temperature rise of the k-th heating element is reflected,
f has an absolute humidity as an input and a hydrogen concentration as an output, and
k is an integer between 1 and n.

17. The apparatus according to claim 16, wherein the at least one processor is further configured to diagnose the external temperature sensor as faulty based on determining that the temperature of the external gas is out of a predetermined normal temperature range.

18. The apparatus according to claim 16, wherein the at least one processor is further configured to diagnose a thermal conductive temperature sensor as faulty based on determining that at least one of the plurality of heating element measurement values is out of a predetermined normal heating element range.

19. The apparatus according to claim 16, wherein the at least one processor is configured to, based on determining that at least one of the hydrogen concentration or the absolute humidity in the external gas is out of a predetermined normal concentration range, diagnose an error in one or both of the hydrogen concentration or the absolute humidity determined by the at least one processor.

20. The apparatus of claim 14, wherein the plurality of heating elements comprises a plurality of micro-electro mechanical system (MEMS) heating elements.
